(19) United States
(12) Patent Application Publication
(10) Pub. No.: US 2007/0088509 A1
(43) Pub. Date: Apr. 19, 2007

(54) Method and system for selecting a marker molecule

(75) Inventors: Jie Cheng, Princeton, NJ (US); Mathaeus Dejori, Munich (DE); Marin Stetter, Munich (DE); Bernd Wachmann, Lawrenceville, NJ (US)

Correspondence Address: STAAS & HALSEY LLP, SUITE 700, 1201 NEW YORK AVENUE, N.W., WASHINGTON, DC, 20005, US

(73) Assignee: SIEMENS AKTIENGESELLSCHAFT, Munich (DE)

(21) Appl. No.: 11/249,424

(22) Filed: Oct. 14, 2005

(51) Int. Cl. G06F 19/00

(52) U.S. Cl. 702/20

(57) ABSTRACT

Method for selecting at least one potential marker molecule indicating an user defined phenotype feature of an organic object, comprising the steps of providing genotype data of genes of a group of organic objects and phenotype data of said group of organic objects, categorizing said genotype data and said phenotype data to generate categorized data of said group of organic objects, relating statistically said phenotype feature with the generated categorized data to extract genes having a strong statistical relationship with said phenotype feature, wherein the extracted genes and proteins corresponding to said extracted genes are selected as potential marker molecules.

### BACKGROUND OF THE INVENTION

The invention provides a method for selecting at least one potential marker molecule indicating an user defined phenotype feature of an organic object.

FIG. 1 shows a simple example of a biochemical mechanism within an organism. A chromosome of said organism has two areas for encoding proteins formed by genes. In the given example of the chromosome shown in FIG. 1, there are two genes, i. e. gene X and gene Y. On a chromosome there are areas, such as promoter regions which function as genetic switches. If the protein X generated by a gene X is bound to the promoter region from another gene, such as a gene Y, the other gene Y is activated or deactivated, i. e. the gene Y is expressed or inhibited. Accordingly, genes interact in a genetic pathway which can be modeled in a network comprising nodes wherein each node represents a corresponding gene, such as shown in FIG. 2. As can be seen from FIG. 2, the connection between the node representing gene X and the node representing gene Y shows the influence of gene X on gene Y. A gene might activate or suppress another gene. Furthermore bidirectional influences are possible. To each edge of the graph a probabilistic and/or logic function may be assigned.

To investigate pathways within an organism, contrast agents CA are used. FIG. 3 shows a simple example of a normal cell and a tumour cell within an organism. The tumour cell has a surface which is slightly different from the normal cell. The marker molecule MM on the surface of the tumour cell indicates that the cell is abnormal. To visualize this tumour cell, a contrast agent CA, which is attachable to the marker molecule MM, can be attached to the marker molecule MM.

Marker molecules MM can be located on a surface of a cell, within a cell or can be any molecules involved in a biochemical pathway of an organism.

It is an object of the present invention to provide a method and a system for automatically selecting potential marker molecules MM indicating an user defined phenotype feature of an organic object, such as an organism.

### SUMMARY OF THE INVENTION

The invention provides a method and a system for selecting at least one potential marker molecule indicating an user defined phenotype feature of an organic object. In an embodiment according to the present invention, genotype data of genes of a group of organic objects and phenotype data of said group of organic objects is provided. Then the genotype data and the phenotype data is categorized to generated categorized data of said group of organic objects. The phenotype feature is related statistically to the generated categorized data to extract genes or genes combinations having a strong statistical relationship with the phenotype feature. The extracted genes and proteins corresponding to the extracted genes are selected as potential marker molecules.

In an embodiment of the method according to the present invention, the genotype data includes different types of genotype data comprising allelic data of the genes as a first type of genotype data stored in a first data format, gene expression data as a second type of genotype data stored in a second data format, and proteomic data of proteins corresponding to the genes as a third type of genotype data stored in a third data format.

In one embodiment of the method according to the present invention, the phenotype data includes different types of phenotype data comprising imaging data as a first type of phenotype data stored in a first data format,

blood profile data as a second type of phenotype data stored in a second data format,

urine metabolic data as a third type of phenotype data stored in a third data format,

physical data as a fourth type of phenotype data stored in a fourth data format,

demographic data as a fifth type of phenotype data stored in a fifth data format, and

user defined phenotype feature data a sixth type of phenotype data stored in a sixth data format.

In an embodiment of the method according to the present invention, the different types of genotype data and the different types of phenotype data are each categorized respectively by performing the following steps, i. e. normalizing the data to generate normalized data, calculating a relevant indicative value on the basis of said normalized data and comparing the calculated value to at least one user defined threshold value to generate the categorized data.

In an embodiment of the method according to the present invention, the phenotype feature is related statistically with the generated categorized data by means of a machine learning algorithm.

In one embodiment of the method according to the present invention, the machine learning algorithm is a learning Bayesian network algorithm.

In one embodiment of the method according to the present invention, each categorized type of data forms a node of a network, wherein statistical relationships between said nodes are extracted by means of a machine learning algorithm.

In one embodiment of the method according to the present invention, each type of genotype data and each type of phenotype data is stored in a corresponding database.

In a preferred embodiment of the method according to the present invention, for each marker molecule a complementary contrast agent, which is attachable to the marker molecule, is selected.

The selected contrast agent is used for molecular imaging of an activation ste of a pathway in which the marker molecule is involved.

In an embodiment of the method according to the present invention, imaging of said pathway is performed by means of X-rays, magnetic resonance, ultrasound or nuclear radiation sensing devices.

In a preferred embodiment of the method according to the present invention, the phenotype feature is related statistically to the generated categorized data by specifying statistical dependencies between said phenotype feature and the generated categorized data.

The investigated organic objects are formed either by cells, organic tissues, organs, organisms, human beings, plants or micro-organisms.

The invention further provides a system for selecting at least one marker molecule indicating a phenotype feature of an organic object comprising:

a first database for storing genotype data of genes of a group of organic objects,

a second database for storing phenotype data of said group of organic objects, and

a calculation unit connected to the first and the second database for categorizing the genotype data and the phenotype data to generate the categorized data of the group of organic objects,

wherein the calculation unit relates statistically the phenotype feature with the generated categorized data to extract genes having a strong statistical relationship with the phenotype feature,

wherein the extracted genes and proteins corresponding to the extracted genes are output by the calculation unit as marker molecules.

In a preferred embodiment, for each selected marker molecule a complementary contrast agent, which is selectively attachable to the marker molecule, is selected. The selected contrast agent can be used for molecular imaging of a pathway in which said marker molecule is involved.

In the following preferred embodiments of the method and the system for selecting potential marker molecules indicating an user defined phenotype feature of an organic object are described with reference to the enclosed drawings and the detailed description below.

### BRIEF DESCRIPTION OF THE DRAWINGS

FIG. 1 shows a diagram illustrating the functionality of genes within a biochemical pathway of an organism;

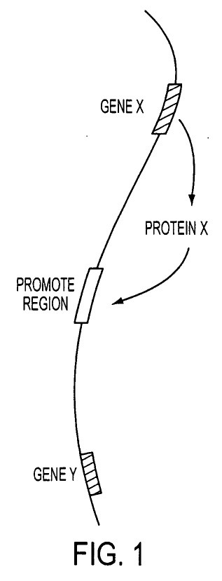

FIG. 2 shows a diagram illustrating a genetic pathway;

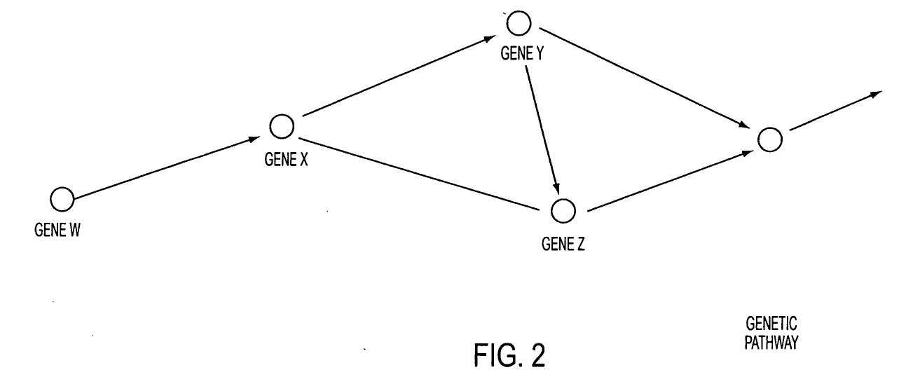

FIG. 3 shows a diagram illustrating a marker molecule and a contrast agent;

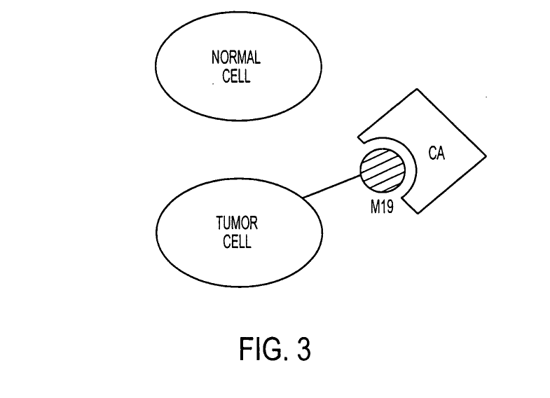

FIG. 4 shows a block diagram of the computer system according to the present invention;

FIG. 5 shows a block diagram of the preferred embodiment of the computer system according to the present invention;

FIG. 6 shows a database as a simple example for illustrating the functionality of the method according to the present invention;

FIG. 7 shows a diagram for illustrating the categorizing of a data according to the present invention.

FIG. 8 shows a flowchart of an embodiment of the method according to the present invention.

### DESCRIPTION OF PREFERRED EMBODIMENTS

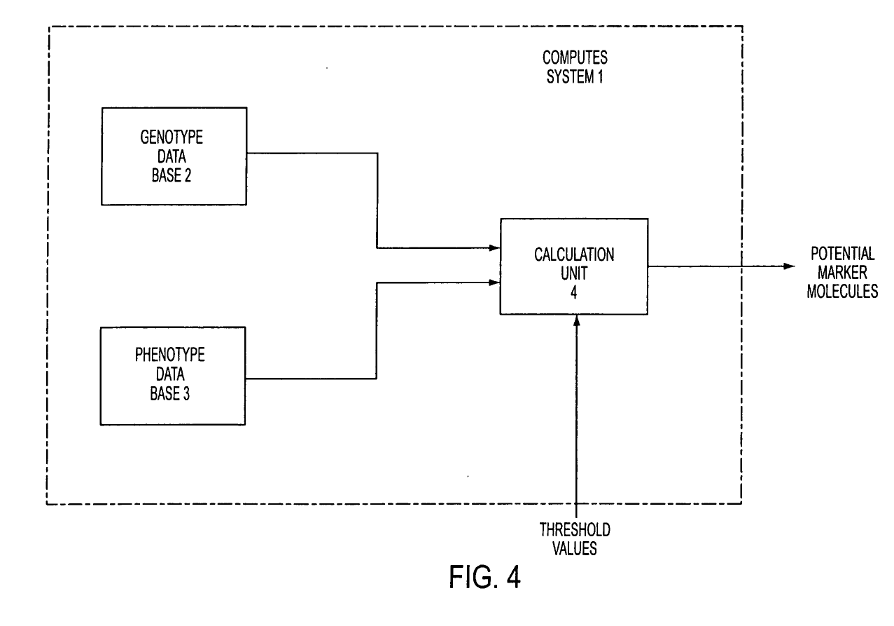

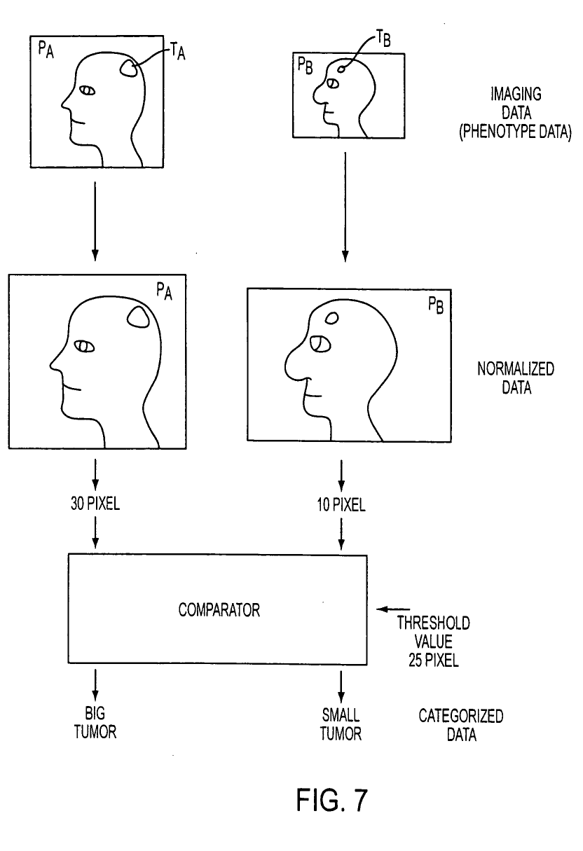

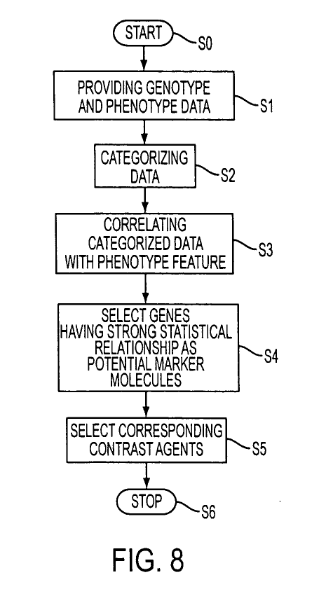

As can be seen from FIG. 4, a computer system 1 according to the present invention comprises at least one genotype database 2 and at least one phenotype database 3. FIG. 8 shows a flowchart of the method according to the present invention. The genotype database 2 and the phenotype database 3 are connected to a calculation unit 4 to which user defined threshold values for categorizing the data are input. The databases 2, 3 are either public databases or user defined databases. The computer system 1 according to the present invention employs a modular structure with respect to the original kind of data stored in the databases 2, 3. Possible databases are a PACS database for image data, BioChip databases for gene expression data and SNP databases for SNP/Haplotype/gene mutational data. The modular structure of the computer system 1 according to the present invention can be flexibly extended to other sources of data, such as protein interaction data, mass spectrometry data and various kinds of clinical phenotype data besides imaging. The genotype databases 2 store genotype data of genes of a group of organic objects. The phenotype databases 3 store phenotype data of the same group of organic objects. The investigated organic objects are either cells, organic tissues, organs, organisms, in particular human beings, plants or microorganisms. The calculation unit 4 which is directly or via a network connected to the genotype databases 2 and the phenotype databases 3 categorizes in step S2 as shown in FIG. 8 the input data to generate categorized data of said group of organic objects. Categorizing of the data is performed by first normalizing the data to generate normalized data. On the basis of the normalized data, at least one relevant indicative value is calculated and compared to at least one user defined threshold value to generate categorized data as explained in more detail with reference to FIG. 7.

The calculation unit 4 relates in step S3 a user defined phenotype feature of the investigated organic object with the generated categorized data to extract genes G having a strong statistical relationship with the phenotype feature. The extracted genes G and proteins P corresponding to the extracted genes are output by the calculation unit 4 after step S4 as potential marker molecules MM. For the selected potential marker molecules corresponding complementary contrast agents CA, which are attachable to the respective marker molecules are selected in step S5. The selected contrast agents CA can be used for molecular imaging of the pathway of said organism in which the marker molecule MM is involved.

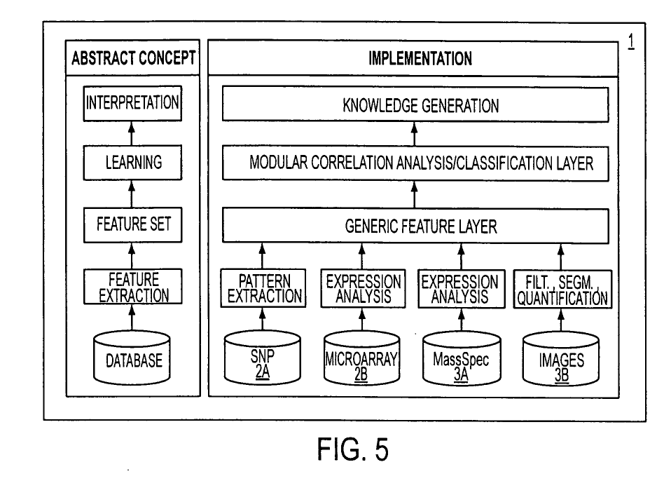

FIG. 5 shows a block diagram for illustrating a preferred embodiment of the computer system 1 for selecting a potential marker molecule according to the present invention. The computer system 1 according to the present invention provides for each data source a data specific analysis and feature extraction tool. The extracted features are then stored in a generic feature layer or meta-layer which provides the basis for advanced analysis.

In the embodiment shown in FIG. 5, the computer system 1 according to the present invention processes data from four different data sources or databases 2A, 2B, 3A, 3B. The first two databases 2A, 2B store genotype data and the other data bases 3A, 3B store phenotype data. The database 2A is a database which stores Single-Nucleotide Polyphormism (SNP) data as a form of genotype data of the investigated organisms. The second database 2B stores gene expression data as a second type of genotype data in other data format.

The third database 3A stores mass spectroscopic data as a type of phenotype data in a corresponding data format. The forth database 3B stores image data as a further type of phenotype data in another corresponding data format.

As can be seen from FIG. 5, each database has a corresponding data format which differs dramatically from the format of the other databases. There is for instance numeric scalar data for expression values, numeric vectors for mass spectrometry data and two-dimensional/three-dimensional image data.

On the basis of the different data sources storing genotype data and phenotype data, the computer system 1 according to the present invention categorizes separately the respective genotype data and the respective phenotype data of each database 2, 3 separately to extract categorized data to a generic feature layer. In this way, it is possible to handle heterogeneous data from different data sources. After categorizing of the data has been performed by means of user defined input, the computer system 1 subsequently relates statistically a user defined phenotype feature of the investigated organism with the categorized data to extract genes having a strong statistical relationship with this phenotype feature. In an embodiment of the computer system 1 according to the present invention, the statistical relation is performed by correlating the phenotype feature with the generated categorized data. The extracted genes and proteins corresponding to the extracted genes are selected by the computer system 1 as potential marker molecules MM for which complementary contrast agents CA can be found.

The correlation analysis is run at the meta-layer level so that it is independent of the structure of the data giving rise to the feature combination. In a preferred embodiment, the user defined phenotype feature is related statistically with the generated categorized data by means of a machine learning algorithm. This machine learning algorithm is in a preferred embodiment a learning Bayesian network algorithm.

The modularity of the computer system 1 according to the present invention allows flexible adaption to user needs. Emphasizis is put on data pre-processing and feature extraction used to generate the meta-layer categorized data as shown in FIG. 5.

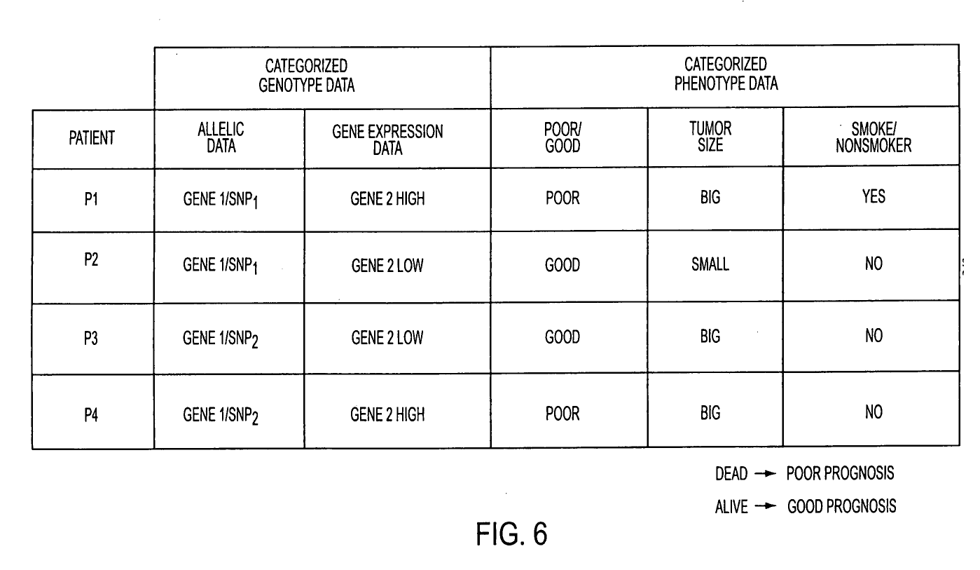

FIG. 6 shows a simple example for a meta-data layer consisting of categorized data used for subsequent correlation analysis to extract genes having a strong statistical relationships with the phenotype feature defined by a user. The data as shown in FIG. 6 consists of categorized genotype data and categorized phenotype data. The organisms selected for investigation are patients P1-P4 treated in a hospital. The phenotype data of the patients P consists of the information whether he has a poor prognosis or a good prognosis, the size of the tumour and the fact whether the patients are smokers or non-smokers. Furthermore, the categorized genotype data indicates a Single-Nucleotide Polyphormism SNP of a gene 1 and gene expression data of a gene 2. On the basis of the categorized data as shown in FIG. 6, the correlation analysis is performed.

First, the user defines phenotype feature for which he wishes to find a potential marker molecule MM. For instance, the user defines the phenotype feature whether the patient has a good or poor prognosis. The selected phenotype feature is related statistically with the categorized data as shown in FIG. 6 to extract genes having a strong statistical relationship with the phenotype feature. In the given example, there is a 100% correlation between the gene expression data of gene 2 and the phenotype feature “poor/good”. When the gene expression of gene 2 is low, the non-smoking patients P2, P3, P4 have a good prognosis, whereas, when the gene expression of gene 2 is high, the investigated patients P2, P3, P4 are dead. Consequently, gene 2 and the corresponding protein generated by gene 2 are a potential molecule MM for indicating an user defined phenotype feature “non smoking patient has poor prognosis/good prognosis”. For the found marker molecule MM, a complementary contrast agent CA, which is chemically attachable to the marker molecule, can be selected and used for molecule imaging of this biochemical pathway of the organism. The imaging of the pathway is either performed by means of X-rays, magnetic resonance, ultrasound or nuclear radiation sensing devices.

FIG. 7 shows an example for categorizing raw data such as phenotype raw data in the form of imaging data. The image taken of two different patients PA, PB is first normalized to the same size and the number of pixels showing a tumour T in the brain of both patients are counted on the basis of the normalized data. In the given example, the normalized data of patient PA comprises 30 pixels and the tumour of patient PB comprises 10 pixels. The user inputs a threshold value for categorizing the normalized data. The user defines a tumour T having more than 25 pixels to be a big tumour whereas a tumour T having less than 25 pixels is regarded to be a small tumour. As can be seen from FIG. 7, the categorized data comprises “small tumour” for patient B and “big tumour” for patient B. This categorized data is stored in a meta-layer as categorized phenotype data, such as in the example of FIG. 6.

A researcher might want to search for SNPs and genes that are likely to be involved in a disease mechanism and to find corresponding marker molecules. This is done by using the search function for BioChip databases and an SNP database. For the investigated patients, a genetic testing is performed specifying the allele combinations and the results are stored in the computer system 1. Transparent to the user, the computer system 1 initiates an upload of allele data to the SNP database and keeps the link to the experiment and patient. Subsequently, a number of gene expression experiments are carried out and eventually under different conditions, i. e. before and after treatment, early disease, progressed disease etc. The resulting expression data is also stored in the computer system 1. Transparent to the user, the computer system 1 initiates an upload to a BioChip database and keeps links to the patients and the experiment. Finally, the investigated patients are in parallel imaged and phenotyped in various other ways. The resulting data is stored in the computer system 1. On the basis of this data, the researcher analyzes the data to extract genotype/phenotype relationships, gene expression/phenotype relationships and eventually mutative molecular disease pathways.

Furthermore, the researcher might be primarily interested in studying the impact of certain SNPs upon signal transduction pathways which later may cause diseases. The researcher collects information about all genes which are known to participate in a certain signal transduction pathway. In the next step, the SNPs are identified which are in or close to one of the respective genes within a range defined by a certain threshold. The SNPs are then classified into coding and non-coding wherein the latter are only accepted in case they are within a known enhancer-promoter region of a gene and part of an intronic sequence that could play a role in splicing or alternative splicing. The coding SNPs are subclassified in synonymous or non-synonymous wherein the latter are used for subsequent analysis. The impact of SNPs is analyzed, i.c. whether they might have an impact on the protein structure or not. Based on the SNP pattern which has been identified by said process a representative patient population, i. e. a test group, is searched for in the database which contain individuals having one or more of these SNPs. The control group of individuals having none of these SNPs is collected as well.

For both above described scenarios, the user, i. e. the researcher, can identify molecules which are involved in pathways of the organism, i. e. tRNA, mRNA, proteins etc. These found marker molecules MM are then the primary target for a contrast agent development, said contrast agents CA being selectively attachable to the target molecules. The found contrast agents CA are then used for image acquisition with X-rays, magnetic resonance, ultrasound or nuclear radiation sensing devices.

Some data stored in databases is already categorical, such as SNP data. In contrast, gene expression data requires the step of gene selection. In the computer system 1 according to the present invention, manual gene selection is supported as well as a number of data driven gene selection techniques.

The system 1 according to the present invention provides univariate tests, such as correlation, statistical dependency analysis to check for differential expression with respect to the experimental conditions, e. g. time, pharmacological treatment, drug dose etc. and correlation and statistical tests to check for differential expressions with genotypic information, i. e. behavior of one SNP or Haplotype and occurrence of a pattern of SNPs motivated by the location and potential impact on the expression of a certain gene or group of genes.

Both independent quantities, i. e. experimental conditions and SNP variance, are present in the feature meta-layer and are henceforth available for analysis. In an embodiment of the present invention, a T-test, ANOVA, a Chi-square dependency test, an Entropy test, Kolmogorov-Smirnov-Test, Markhof Blanket and mutual information are provided to check correlations. In a preferred embodiment, in order to avoid that the test yields many false positive, false discovery thresholding, a logic combination of tests and performance estimation by cross-validation is provided.

After the gene selection discretization of expressional levels is performed. Depending on the type of distribution and type of discretization, the discretization thresholds are determined according to standard deviation of expressional levels or the minimization of the entropy by applying the minimum description length principle across patients.

Once the feature meta-layer is generated by the use of feature extraction components, genotype/phenotype relations are learned on the basis of a predictive model. With this purpose association mining and collaborative filtering are deployed for an unsupervised screening of the data.

In addition, robust learning Bayesian networks are applied with causal interpretation to extract by a machine learning process relationships between different entities of the feature level. Each feature type, e. g. SNP, gene expression and tumour size is represented by the network. The machine learning consists of finding statistical relationships between the nodes which are graphically represented by edges and a set of probability values.

The stored genotype data is treated as unconditional causes. During the learning process, the genotype data are related to other features like gene expression levels and to phenotypic outcomes. The effect of experimental conditions is taken into account by including them in the network to be learned as well.

After the machine learning, the following probabilistic knowledge can be extracted:

Feature selection: Many nodes in the network do have no or weak interaction with others. Some nodes, however, strongly interact with each other and/or phenotypic features. These nodes are identified as key features on the basis of the data.

Causal pathways: Relationships and associations between different molecular or macroscopic entities are made explicit.

Predictive power: By taking into account many features simultaneously, a superior predictive power is achieved, i. e. SNP, gene, protein and/or metabolite combinations forming a biomarker.

Generative modeling: Once generated, the predictive model is used to play in-silico-what-if-scenarios to conduct virtual experiments before these experiments are actually carried out in the wet lab.

Stratification: Patients are stratified into groups which may have similar molecular and phenotype feature patterns.

Personalization: The analysis allows revealing the differences in the patient population with respect to responses to drugs and other forms of treatment, consequently leading to a personalized treatment by avoiding potential risk factors.

Feedback for the experimentalist: The analysis allows a comparison of the diagnostic and predictive power of each modality. Therefore, it is possible to make improvement suggestions for both, the sample preparation and data acquisition.

In a preferred embodiment, the method for selecting at least one potential marker molecule indicating an user defined phenotype feature of an organic object is performed by a program stored on a data carrier.

1. A method for selecting at least one potential marker molecule indicating an user defined phenotype feature of an organic object, comprising the following steps:
(a) providing genotype data of genes of a group of organic objects and phenotype data of said group of organic objects;
(b) categorizing said genotype data and said phenotype data to generate categorized data of said group of organic objects;
(c) relating statistically said phenotype feature with the generated categorized data to extract genes having a strong statistical relationship with said phenotype feature;
(d) wherein the extracted genes and proteins corresponding to said extracted genes are selected as potential marker molecules.

2. The method according to claim 1,
wherein said genotype data includes different types of genotype data comprising:
allelic data of said genes as a first type of genotype data stored in a first data format,
gene expression data as a second type of genotype data stored in a second data format, and
proteomic data of proteins corresponding to said genes as a third type of genotype data stored in a third data format.

3. The method according to claim 1,
wherein said phenotype data includes different types of phenotype data comprising:
imaging data as a first type of phenotype data stored in a first data format,
blood profile data as a second type of phenotype data stored in a second data format,
urine metabolic data as a third type of phenotype data stored in a third data format,
physical data as a fourth type of phenotype data stored in a fourth data format,
demographic data as a fifth type of phenotype data stored in a fifth data format, and
user defined phenotype feature data a sixth type of phenotype data stored in a sixth data format.

4. The method according to claim 2,
wherein said different types of genotype data and said different types of phenotype data are each categorized respectively by performing the following steps:
(b1) normalizing the data to generate normalized data;
(b2) calculating a relevant indicative value on the basis of said normalized data; and
(b3) comparing the calculated value to at least one user defined threshold value to generate said categorized data.

5. The method according to claim 1,
wherein said phenotype feature is related statistically with the generated categorized data by means of a machine learning algorithm.

6. The method according to claim 5,
wherein said machine learning algorithm is a learning Bayesian network algorithm.

7. The method according to claim 4,
wherein each categorized type of data forms a node of a network,
wherein statistical relationships between said nodes are extracted by means of a machine learning algorithm.

8. The method according to claim 2,
wherein each type of genotype data and each type of phenotype data is stored in a corresponding database.

9. The method according to claim 1,
wherein for each marker molecule a complementary contrast agent which is selectively attachable to said marker molecule is selected.

10. The method according to claim 9,
wherein said selected contrast agent is used for molecular imaging of a pathway in which said marker molecule is involved.

11. The method according to claim 10,
wherein imaging of said pathway is performed by means of x-rays, magnetic resonance, ultrasound or nuclear radiation sensing devices.

12. The method according to claim 1,
wherein said phenotype feature is related statistically with the generated categorized data by correlating said phenotype feature with the generated categorized data.

13. The method according to claim 1,
wherein the organic objects are formed by cells.

14. The method according to claim 1,
wherein the organic objects are formed by organic tissues.

15. The method according to claim 1,
wherein the organic objects are formed by organs.

16. The method according to claim 1,
wherein the organic objects are formed by organisms.

17. The method according to claim 16,
wherein the organic objects are formed by human beings.

18. The method according to claim 1,
wherein the organic objects are formed by plants.

19. The method according to claim 1,
wherein the organic objects are formed by micro-organisms.

20. A system for selecting at least one marker molecule indicating a phenotype feature of an organic object comprising:
a first database for storing genotype data of genes of a group of organic objects;
a second database for storing phenotype data of said group of organic objects; and
a calculation unit connected to the first and the second database for categorizing said genotype data and said phenotype data to generate the categorized data of said group of organic objects,
wherein the calculation unit relates statistically said phenotype feature with the generated categorized data to extract genes having a strong statistical relationship with said phenotype feature,
wherein the extracted genes and proteins corresponding to said extracted genes are output by said calculation unit as marker molecules.

21. A computer program for selecting at least one potential marker molecule indicating an user defined phenotype feature of an organic object,
said computer program comprising the following steps:
(a) providing genotype data of genes of a group of organic objects and phenotype data of said group of organic objects;
(b) categorizing said genotype data and said phenotype data to generate categorized data of said group of organic objects;
(c) relating statistically said phenotype feature with the generated categorized data to extract genes having a strong statistical relationship with said phenotype feature;
(d) wherein the extracted genes and proteins corresponding to said extracted genes are selected as potential marker molecules.

22. A data carrier for storing a computer program for selecting at least one potential marker molecule indicating an user defined phenotype feature of an organic object,
said computer program comprising the following steps:
(a) providing genotype data of genes of a group of organic objects and phenotype data of said group of organic objects;
(b) categorizing said genotype data and said phenotype data to generate categorized data of said group of organic objects;
(c) relating statistically said phenotype feature with the generated categorized data to extract genes having a strong statistical relationship with said phenotype feature;
(d) wherein the extracted genes and proteins corresponding to said extracted genes are selected as potential marker molecules.

23. A method for selecting at least one contrast agent being selectively attachable to a corresponding marker molecule indicating an user defined genotype feature of an organic object, comprising the following steps:
(a) providing genotype data of genes of a group of organic objects and phenotype data of said group of organic objects;
(b) categorizing said genotype data and said phenotype data to generate categorized data of said group of organic objects;
(c) relating statistically said phenotype feature with the generated categorized data to extract genes having a strong statistical relationship with said phenotype feature;
(d) wherein the extracted genes and proteins corresponding to said extracted genes are selected as potential marker molecules,
(e) wherein for each selected marker molecule a complementary contrast agent which is selectively attachable to said marker molecule is selected,
(f) wherein said selected contrast agent is used for molecular imaging of a pathway in which said marker molecule is involved.

24. The method according to claim 3,
wherein said different types of genotype data and said different types of phenotype data are each categorized respectively by performing the following steps:
(b1) normalizing the data to generate normalized data;
(b2) calculating a relevant indicative value on the basis of said normalized data; and
(b3) comparing the calculated value to at least one user defined threshold value to generate said categorized data.

25. The method according to claim 24,
wherein each categorized type of data forms a node of a network,
wherein statistical relationships between said nodes are extracted by means of a machine learning algorithm.

26. The method according to claim 3,
wherein each type of genotype data and each type of phenotype data is stored in a corresponding database.
